(19) United States
(12) Patent Application Publication
(10) Pub. No.: US 2002/0067078 A1
(43) Pub. Date: Jun. 6, 2002

(54) Vehicle security steering wheel

(76) Inventor: Stanley Hogarth, Strathaven (GB)

Correspondence Address: Sherman D. Pernia, 1110 NASA Road One, Suite 450, Houston, TX, 77058-3310, US

(21) Appl. No.: 09/754,881

(22) Filed: Jan. 5, 2001

(30) Foreign Application Priority Data
Jan. 7, 2000 (GB) 0000264.2
Mar. 31, 2000 (GB) 0007734.7

(51) Int. Cl. B60R 25/00

(52) U.S. Cl. 307/10.2

(57) ABSTRACT

A vehicle security steering wheel comprising a spoke and rim assembly disengageably connected by a locating plate to a hub; the hub is secured to the steering mechanism of the vehicle. The assembly is attached to the hub by a pivot means at their common axis. When the locating plate is disengaged the assembly is free to concentrically revolve around the hub and so prohibits the revolving motion of the assembly being transferred to the steering mechanism of the vehicle. The locating plate is radially positioned to engage and disengage with an aperture with in the device; this radial movement is conveyed by an electrical motor means, return springs and linkage. Included in the device is a locking pin and locating plate stop to prevent unintentional movement of the locating plate, the releasing and locking movement of the locking pin in conveyed by an electrical motor means, return springs and linkage. The sequence of movements is controlled by an electronic control board.

### BACKGROUND OF THE INVENTION

Over recent years the incidence of vehicle theft has risen and is one of the major crimes worldwide. Many of the devices in use which attempt to prevent the engine from being started so as to frustrate vehicle theft often fail in their objective. Other removable mechanical devices such as steering wheel locks, gear stick locks and steering column locks are often easily overcome or broken by the determined thief. It would be useful to have an alternative means of vehicle theft prevention that is integral to the vehicle rather than removable, and which does not require disabling the electrical system of the vehicle in some fashion.

### SUMMARY OF THE INVENTION

The object of the present invention is to prevent a parked or unattended vehicle from being driven away by a thief or an unauthorized person. This is accomplished by disabling the steering system of the vehicle so that the vehicle cannot be driven away even if the engine can be started. This invention is designed so that it cannot be overcome by brute force and can be further protected electronically by the use of a SIM card removal procedure.

According to a first aspect of the present invention, there is provided a vehicle security steering wheel (the device) for use in a vehicle, such as a truck or automobile. The device is essentially similar to a normal steering wheel. The device is attached by its hub to the steering column in the normal way. The device has a mechanical locating (locking) plate which connects the hub to the spoke and rim assembly of the device so that the vehicle can be steered in the usual way. Disengagement of the locating plate can be effected so that the spoke and rim assembly revolves freely around the hub by way of a pivot. The pivot fits into the center of the hub and is attached to the spoke and rim assembly. This disengagement prevents the transfer of the revolving motion of the steering wheel to the hub and then onto the steering column so disabling the steering system of the vehicle.

The locating plate may be situated within the spoke and rim assembly of the device and can engage and disengage with an aperture within the hub. Alternatively the locating plate may be situated within the hub of the device and can engage and disengage with an aperture within the spoke and rim assembly.

Preferably the locating plate is adapted to fit in a housing within the device so that it can freely slide out and in of the housing and can engage and disengage with the aforementioned aperture. At all times part of the locating plate remains engaged within the aforementioned housing.

Preferably the sliding movement means comprises an electrical motor means, such as a solenoid, adapted to cause said locating plate to slide out and in of the housing so causing the spoke and rim assembly and the hub to engage and disengage. Preferably the electrical motor means is linked to the locating plate by a connecting member.

Preferably the pivot which is attached to the spoke and rim assembly fits into a central socket 9 in the hub and is conveniently sized so that the spoke and rim assembly can revolve freely around the hub. The pivot may be of hollow construction to allow access to a steering column securing bolt, nut or other securing means (FIGS. 4 & 4A).

According to a second aspect of the present invention, there is provided a locking pin fitted within the device which prevents the locating plate from accidentally sliding out of its engaged and disengaged position. The locking pin engages with a stop part of the locating plate to prevent movement of the locating plate and is retracted from the locking position when the locating plate is required to engage or disengage with the aforementioned aperture.

Preferably the movement of the locking pin means comprises an electrical motor means, such as a solenoid, adapted to cause said locking pin to engage and disengage with a stop part of the locating plate. Preferably the electrical motor means is connected to the locking pin by a connecting member.

Preferably there includes a control apparatus to operate the locating plate solenoid and locking pin solenoid.

Preferably the solenoids are timed to operate sequentially as required. The timers may be electronically controlled. Springs 13 may be used in the operation (see FIGS. 3 & 3A).

Preferably the dimensions and shapes of the aperture and the locating plate in the device are such that their engagement and disengagement is made easy and when engaged the device operates like a normal steering wheel.

Preferably there is an air bag chamber 7 in the spoke and rim assembly to allow the normal fitting of an air bag safety apparatus (not shown) to the device (see FIGS. 4 & 4A)

Preferably the electrical supply to the device will be isolated from the device when the ignition key of the vehicle is in place and switched to any position. This will ensure that unintended disengagement cannot happen whilst the vehicle is in motion.

Preferably various types of hubs to suit various types of vehicles are interchangeable with the rim & spoke assembly. The spoke and rim assembly and hub will be held laterally positioned to each other with a retaining ring 11 and retaining fasteners 17 (see FIGS. 4 & 4A).

Preferably the electrical power source will be provided to the device as is normally achieved to a normal steering wheel.

### BRIEF DESCRIPTION OF THE DRAWINGS

FIG. 1 is a top plan view of the device showing the internal workings in the engaged/steering condition when the steering system is enabled.

FIG. 2 is a top plan view of the device showing the internal workings in the disengaged/free condition when the steering system is disabled.

FIG. 3 is a perspective view of the mechanism showing the locating plate with its operating solenoid and the locking pin with its operating solenoid in the disengaged/free condition.

FIG. 3A is a perspective view of the mechanism showing the locating plate with its operating solenoid and the locking pin with its operating solenoid in the engaged/steering condition.

FIG. 4 is a side cross-sectional view of the device showing how the profile of the spoke and rim assembly fits around the hub in the disengaged/free condition.

FIG. 4A is a side cross-sectional view of the device showing how the profile of the spoke and rim assembly fits around the hub in the engaged/steering condition.

FIG. 5 is a perspective view of the hub of the device.

### DETAILED DESCRIPTION OF THE INVENTION

Referring now to the drawings, the details of preferred embodiments of the present invention are graphically and schematically illustrated. Like elements in the drawings are represented by like numbers, and any similar elements are represented by like numbers with a different lower case letter suffix.

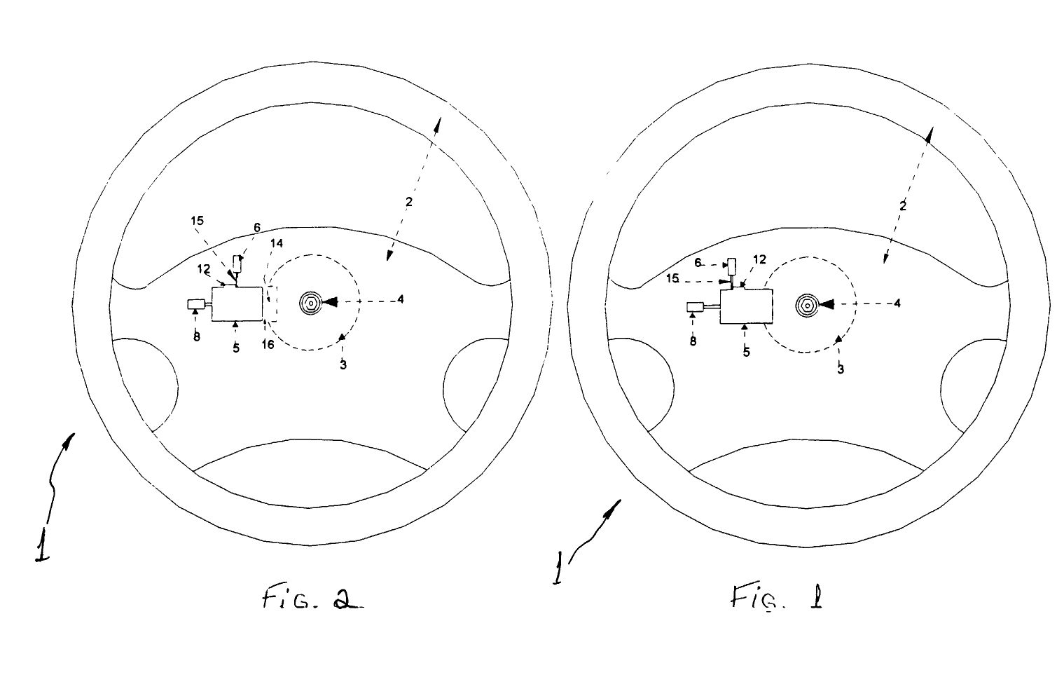

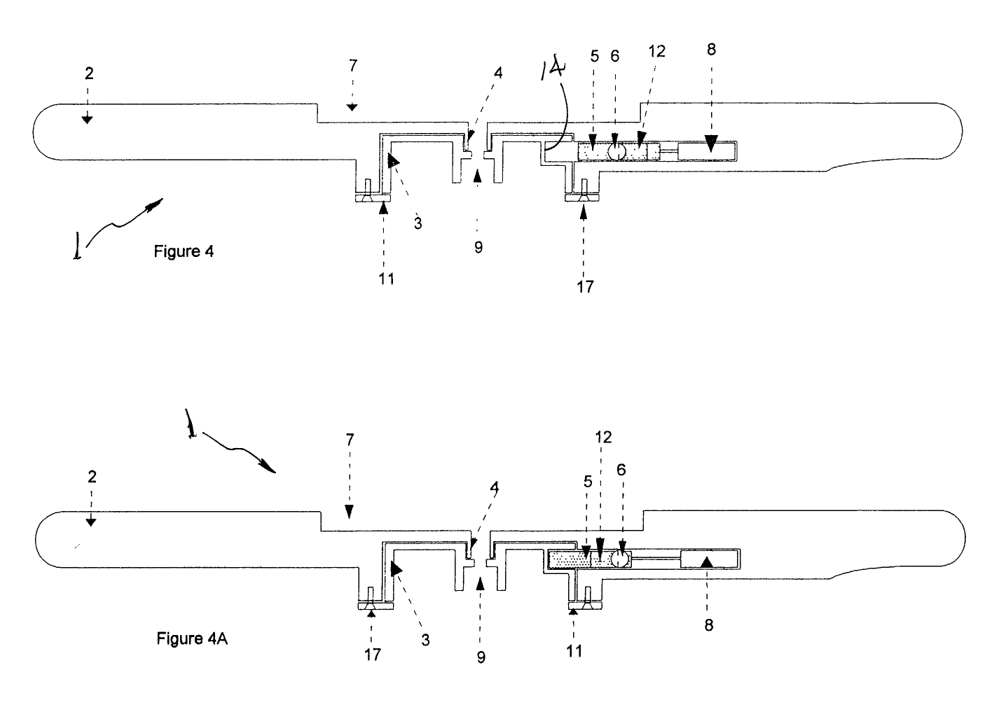

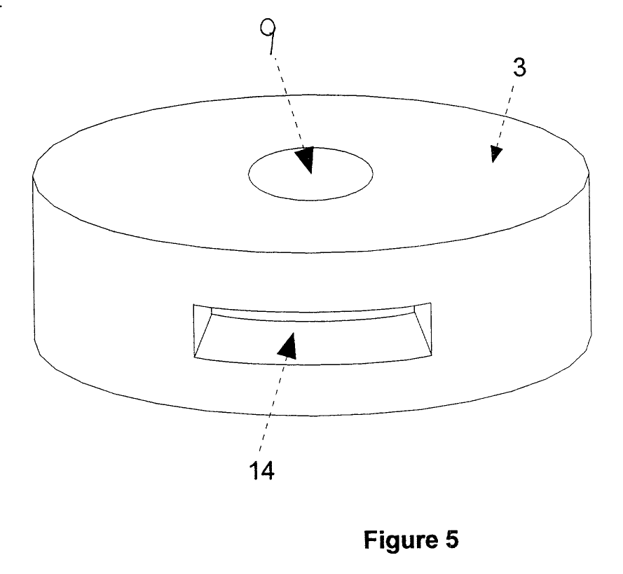

Referring to FIGS. 1 to 5, the spoke and rim assembly 2 are of integral construction and are fitted to a separate hub 3 construction by means of a pivot 4 so that the outer circumference of the spoke and rim assembly 2 and the outer circumference of the hub 3 are concentric. Contained within the spoke and rim assembly 2 is the mechanism 10 with the locating plate 5 and the locking pin 15 and the solenoids 6 and 8.

With the locating plate 5 of the device 1 engaged with the aperture 14 in the hub 3, the steering system can be used to steer the vehicle in the normal manner. The device 1 is in the engaged/steering condition (FIGS. 1, 3A & 4A)

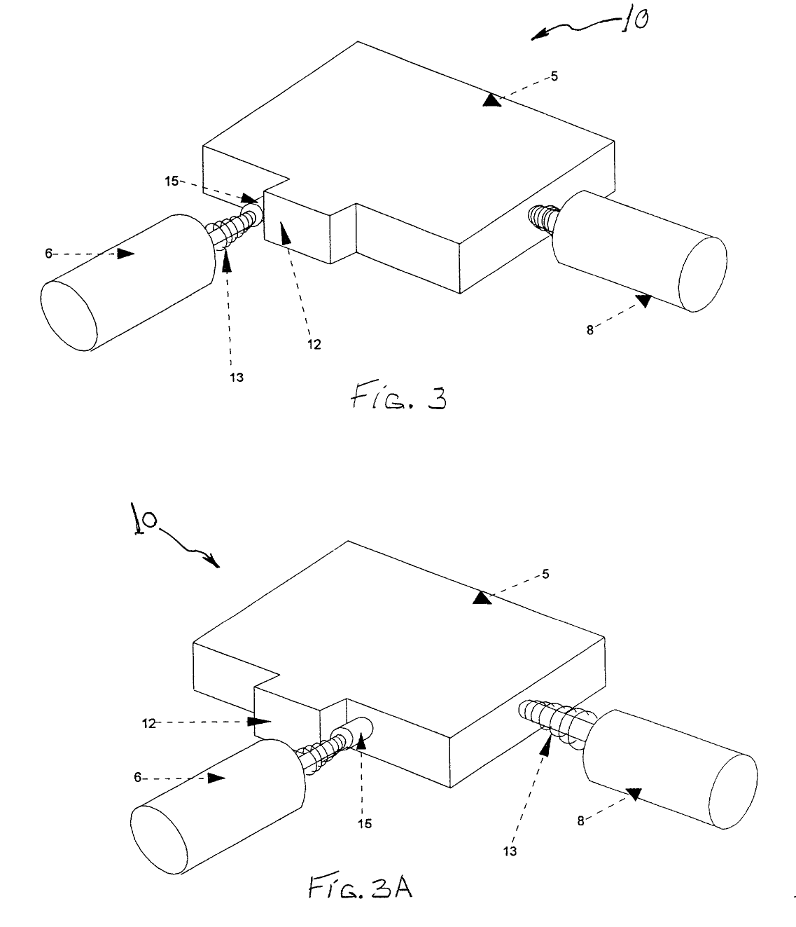

When the device 1 is required to disable the steering system of the vehicle it is activated by the use of an external actuator (not shown). Examples of such external actuators include: electronic key pads and remote control units, such as infrared remote control units. Activation of the mechanism 10, first causes the solenoid 6 to withdraw the locking pin 15 from the locating plate stop 12, and next causes the solenoid 8 to slide the locating plate 5 from the aperture 14 and so disengage the hub 3 from the spoke and rim assembly 2. Momentarily after the disengagement of the locating plate 5 from the aperture 14 in the hub 3 the solenoid 6 allows the locking pin 15 to return to its locking position at the locating plate stop 12 and hold the locating plate in the disengaged position. The device 1 is in the disengaged/free condition (FIGS. 2, 3 & 4).

When the device 1 is required to enable the steering system of the vehicle it is activated by the use of an infrared remote control appliance to activate the mechanism 10, first causing the solenoid 6 to disengage the locking pin 15 from the locating plate stop 12 and next causing the solenoid 8 to slide the locating plate 5 into the aperture 14 of the hub 3 to engage the hub 3 with the spoke and rim assembly 2. Momentarily after the engagement of the locating plate 5 into the aperture 14 of the hub the solenoid 6 allows the locking pin 15 to return to its locking position at the locating plate stop 12, and to hold the locating plate 5 in the engaged position. The device 1 is in the engaged/steering condition (FIGS. 1, 3A & 4A).

It will be obvious to the ordinary skilled artisan that when the device 1 is changing from the disengaged condition (FIG. 2) to the engaged condition (FIG. 1) there is a chance that the locating plate 5 and the aperture 14 could be misaligned. Therefore, the device 1 is designed with a gap 16 so that when the solenoid 6 withdraws the locking pin 15 the locating plate 5 will slide up to the edge of the hub 3 and the returning locking pin 15 will make contact with the stop 12 and sit on the stop 12 held away from its locating position. When the spoke and rim assembly 2 is revolved to the required position to align the locating plate 5 with the aperture 14, the locating plate 5 will slide into the aperture 14 whereupon the locking pin 15 will automatically move to its locking position.

There may be a plurality of mechanisms 10 and a plurality of apertures 14 within the device 1. The device 1 will be made from materials usually used in the manufacture of normal steering wheels.

While the above description contains many specifics, these should not be construed as limitations on the scope of the invention, but rather as exemplifications of one or another preferred embodiment thereof. Many other variation are possible, which would be obvious to one of ordinary skill in the art. Accordingly, the scope of the invention should be determined by the scope of the appended claims and their equivalents, and not just by the embodiments.

What is claimed is:

1. A vehicle security steering wheel system, including an external actuator, and a security steering wheel device, said security steeling wheel device comprising:
a steering wheel hub having a central socket, the socket defining an axis of rotation for the hub and adapted to fit a steering system of the vehicle in a normal way, and the hub having a perimeter with at least one aperture for reversibly engaging a security mechanism;
a pivot means rotatably attaching the hub to a steering wheel spoke and rim assembly;
a steering wheel spoke and rim assembly rotatably attached to the hub by the pivot means;
a security mechanism attached to the spoke and rim assembly for reversibly engaging the aperture of the hub; and
an electronic control board in operative communication with the external actuator and the security mechanism, the control board for reversibly controlling the engagement of the security mechanism with the aperture of the hub.

2. The device of claim 1, wherein the aperture is configured to closely engage the security mechanism.

3. The device of claim 1, wherein the pivot means is disposed to attach the spoke and rim assembly to the hub concentric to the axis of rotation of the hub.

4. The device of claim 1, wherein the spoke and rim assembly further comprise a housing for containing the security mechanism.

5. The device of claim 1, wherein the security mechanism further comprises:
at least one locating plate slidably mounted on the spoke and rim assembly, the locating plate having a locating plate stop;
a locating plate drive, being an electrical motor means, connected by a linkage to each locating plate and operative to slide the locating plate to reversibly engage the aperture of the hub;
at least one locking pin disposed to releaseably secure the locating plate stop, and
a locking pin drive, being an electrical motor means, connected by a linkage to each locking pin and operative to drive the locking pin against the locating plate stop to secure the locating plate in an engaged or a disengaged disposition with the hub.

6. The security mechanism of claim 5, further comprising a return spring in operative communication with the linkage and the connected electrical motor means to bias the linkage to a normal condition relative to its electrical motor means.

7. The security mechanism of claim 5, wherein the locating plate is mounted radially relative to the central socket of the hub.

8. The security mechanism of claim 5, wherein the electrical motor means is a solenoid.

9. The security device of claim 1, wherein the electronic control board includes a SIM card reader to control engagement and disengagement of the security mechanism with the aperture of the hub, the SIM card reader operable by means of the external actuator being a SIM card.

10. The security device of claim 1, wherein the electronic control board includes a remote control circuit in operative communication with an external actuator that is a remote control unit.

11. The security device of claim 1, wherein the electronic control board includes an infrared activated remote control circuit in operative communication with an external actuator that is an infrared remote control unit.

12. The security device of claim 1, wherein the electronic control board is in operative communication with and operable by means of an external actuator that is an electronic key pad.

13. The device of claim 5, wherein a gap is provided between the security mechanism and the hub, and the locating plate is adapted to have some radial movement across the gap to facilitate the locating plate engaging the aperture.

14. A method of operating the vehicle security steering system of claim 1 to allow authorized operation of the steering system of a vehicle so equipped and prevent unauthorized operation comprising the steps of:
providing an electrical power connection to a security steering wheel device when an ignition switch of the vehicle is in an off-position;
using an external actuator to operate the security steering wheel device to cause operative communication between the steering wheel device with the steering system of the vehicle;
breaking the electrical power connection to the security steering wheel device by switching the ignition switch of the vehicle to an on-position, causing the security steering wheel device to remain securely engaged with the steering system of the vehicle and allow operation of the vehicle's steering system;
disengaging the security steering wheel device from the steering system of the vehicle by switching the vehicle's ignition switch to the off-position to make the electrical power connection to the security steering wheel device and using the external actuator to remove operative communication between the steering wheel device and the steering system of the vehicle and prevent operation of the vehicle's steering system.

15. The method of claim 14, wherein the using step comprises: using the external actuator to operate a control board of the steering wheel device to retract a locking pin from a locating plate stop on a locating plate of a security mechanism fixed to a steering wheel spoke and rim assembly of the steering wheel device and cause the locating plate to engage a hub of the device in operative communication with the steering system of the vehicle to establish operative communication between the steering wheel spoke and rim assemble and the steering system of the vehicle, and extending the locking pin to re-engage the locating plate stop to secure the engagement of the locating plate with the hub.

16. The method of claim 15, further comprising: aligning the locating plate and an aperture on the hub while holding the locking pin away from a locking position on the locating plate and rotationally moving the spoke and rim assembly whereupon the locating plate slides into the aperture and the locking pin engages with the locating plate stop.

17. The method of claim 14, wherein the disengaging step comprises: disengaging the security steering wheel device from the steering system of the vehicle by switching the vehicle's ignition switch to the off-position to make the electrical power connection to the security steering wheel device and using the external actuator to operate a control board of the steering wheel device to retract a locking pin from a locating plate stop on a locating plate of a security mechanism fixed to a steering wheel spoke and rim assembly of the steering wheel device and cause the locating plate to disengage a hub of the device, the hub in operative communication with the steering system of the vehicle, to remove operative communication between the steering wheel device and the steering system of the vehicle, and extending the locking pin to re-engage the locating plate stop to secure the locating plate in the disengaged position and prevent operation of the vehicle's steering system.

18. A vehicle security steering wheel system, including an external actuator, and a security steering wheel device, said security steering wheel device comprising:
a steering wheel hub having a central socket, the socket defining an axis of rotation for the hub and adapted to fit a steering system of the vehicle in a normal way a pivot means rotatably attaching the hub to a steering wheel spoke and rim assembly;
a steering wheel spoke and rim assembly rotatably attached to the hub by the pivot means, the spoke and rim assembly having an interior perimeter communicating with the pivot means with at least one aperture for reversibly engaging a security mechanism;
a security mechanism fixed to the hub and adapted to reversibly engage the aperture of the spoke and rim assembly; and
an electronic control board in operative communication with the external actuator and the security mechanism, the control board for reversibly controlling the engagement of the security mechanism with the aperture of the hub.
